(19) United States
(12) Patent Application Publication
(10) Pub. No.: US 2020/0261857 A1
(43) Pub. Date: Aug. 20, 2020

(54) MeAPO-18 Membranes with Lamellar Crystal Morphology and Their Preparation

(71) Applicant: TOTAL RESEARCH & TECHNOLOGY FELUY, Seneffe (BE)

(72) Inventors: Elena Borodina, Bruxelles (BE); Daniel Curulla-Ferre, Uccle (BE); Nikolai Nesterenko, Nivelles (Thines) (BE); Delphine Minoux, Nivelles (BE)

(21) Appl. No.: 16/637,990

(22) PCT Filed: Aug. 9, 2018
(86) PCT No.: PCT/EP2018/071622

§ 371 Date: Feb. 10, 2020

(30) Foreign Application Priority Data
Aug. 10, 2017 (EP) 17185756.8

(51) Int. Cl. B01D 67/00; B01D 69/10; B01J 20/28; B01D 71/02

(52) U.S. Cl. CPC B01D 67/0051; B01D 69/10; B01D 2323/24; B01D 71/028; B01J 20/28033

(57) ABSTRACT

The invention relates to a method for preparing a MeAPO-18 supported membrane comprising a MeAPO-18 crystal layer on a porous support, wherein the obtained MeAPO-18 supported membrane as a lamellar crystal morphology. The invention is also directed to the said membranes and to their use.

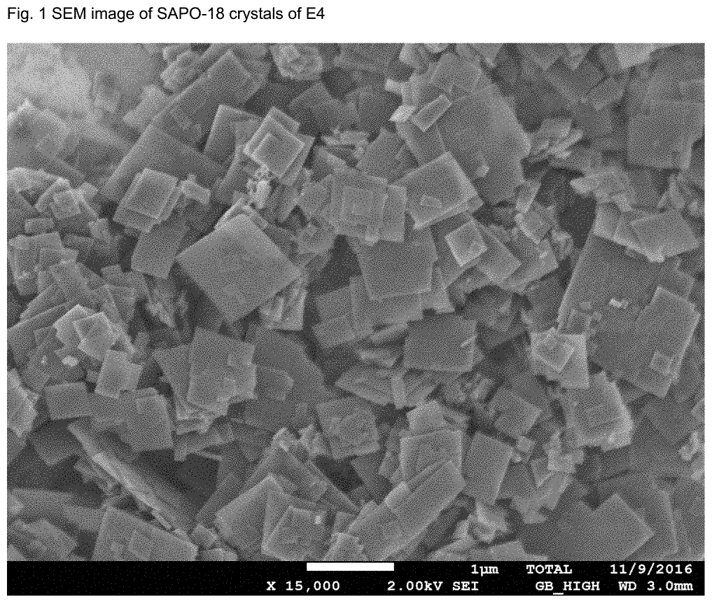

### FIELD OF THE INVENTION

The present invention describes a MeAPO-18 supported membrane and the method thereof preparation. The invention relates to the use of said MeAPO-18 supported membrane.

### BACKGROUND OF THE INVENTION

Metalaluminophosphate membranes, such as silicoaluminophosphate (SAPO) membranes and aluminophosphate (AlPO) membranes, have a three-dimensional microporous crystal framework structure. The cage, channels and cavities created by the crystal framework can permit the separation of mixtures of molecules based on their effective size and absorption properties.

SAPO membranes have been proposed for use in gas separation. The separation selectivity implies that the membrane is selectively permeable to one of the components and not to another one.

US201410352533 describes a method for making silicoaluminophosphate-34 membranes comprising interlocking SAPO-34 crystals. The SAPO-34 membranes are formed through in-situ crystallisation of a porous support using a synthesis mixture initially including a SAPO-34 forming gel and a plurality of SAPO-34 crystals dispersed in the gel.

The synthesis of SAPO/AlPO-18 supported membranes has been described in different publications. The majority of them describe the synthesis of SAPOs supported membranes and their application for the separation of CO₂/CH₄ mixtures. Examples of these publications are M. A. Carreon et al., Chem Comm. 2012 in “AlPO-18 Membranes for CO₂/CH₄ Separation” R. Zhou et al. with a selectivity CH₄CO₂ was calculated to be 60, J of Membr Sci. 2014 in “Alumina-supported AlPO-18 Membranes for CO₂/CH₄ Separation” R. Zhou et al. with a selectivity CH₄/CO₂ was calculated to be 100, J of Mater. Chem. A 2015 in “Improved AlPO-18 Membranes for Light Gas Separation” with a selectivity CH₄CO₂ was calculated to be 220.

CN103449475 relates to a preparation method of an AlPO-18 membrane. The preparation method comprises the following steps: (1) mixing and dissolving aluminium source, tetraethylammonium hydroxide, and phosphoric carrying out hydrothermal synthesis reactions to obtain AlPO-18 molecular sieve crystal seed; (2) coating the AlPO-18 molecular sieve crystal seed on the inner surface of a porous ceramic tube carrier; (3) mixing and dissolving tetraethylammonium hydroxide, and phosphoric acid in water to obtain a molecular sieve membrane synthesis mother liquid, putting the ceramic tube, which has been coated with the AlPO-18 molecular sieve crystal seed, in a molecular sieve membrane synthesis mother liquid, and then carrying out a hydrothermal crystallisation treatment so as to obtain an AlPO-18 molecular sieve membrane after aging: (4) calcinating the membrane tube to remove the template and to obtain an activated AlPO18 molecular sieve membrane. The AlPO18 molecular sieve membrane synthesised by the preparation method is capable of being applied to separations of CO₂/CH₄ and CO₂/H₂ and has a high selectivity throughput of separations of CO₂/CH₄ and CO₂/H₂. The selectivity CH₄CO₂ was calculated to be 41.

CN103894076 discloses a method for preparing a high-performance molecular sieve membrane through ion exchange at a melting state. The method comprises the steps of loading metal salt with the melting point being lower than a calcination temperature onto a molecular sieve membrane, with a templating agent being removed, drying the molecular sieve membrane, and carrying out melting state ion exchange under the situation that the temperature is lower than the calcination temperature and higher than the melting point of metal salt to obtain the ion exchange molecular sieve membrane, wherein the calcination temperature is generated when the templating agent in the molecular sieve membrane is removed. The selectivity CH₄/CO₂ was calculated to be 93.

CN104150503 describes a method for producing a SAPO-18 membrane comprising the steps of preparing seeds by mixing tetraethylammonium hydroxide (TEAOH), an aluminium source, a phosphate, a silicon source and water, with the following molar ratio P₂O₅/Al₂O₃=0.8-3; SiO₂/Al₂O₃=0.02-0.8; TEAOH/Al₂O₃=0.5-3; H₂O/Al₂O₃=50-100. The solution was aged from 4 to 24 hours and the reaction conditions were 5-20 hours at a temperature ranging from 140 to 250° C. The tubular porous support was seeded by impregnation during 0.5-1 hour by immersion of the support in a seed suspension. The membrane was then synthesized using a synthesis mixture comprising tetraethylammonium hydroxide (TEAOH), an aluminium source, a phosphate, a silicon source (being SSZ39 Zeolite) and water, with the following molar ratio P₂O₅/Al₂O₃=0.8-3; SiO₂/Al₂O₃=0.02-0.8; TEAOH/Al₂O₃=1-3; H₂O/Al₂O₃=60-200. The hydrothermal synthesis mixture was aged from 4 to 24 hours and the synthesis conditions were from 3 to 16 hours at a synthesis temperature ranging from 140 to 250° C. The use of a specific of silicon allows having a film thickness of 5 μm or less. The selectivity CH₄CO₂ was calculated to be 110.

CN104785125 describes a method for producing an AlPO-18 membrane, wherein: the seeds are prepared by mixing during 12 hours at a temperature ranging from 100-170° C., tetraethylammonium hydroxide (TEAOH), a source of aluminium, a source of phosphorus and water with the following molar ratio P₂O₅/Al₂O₃=3.16; TEAOH/Al₂O₃=6.32; H₂O/Al₂O₃=186. The seeds are deposited by rubbing on a tubular porous support, and submitted to membrane synthesis during 3 to 24 hours at a synthesis temperature ranging from 150 to 210° C. using a synthesis mixture according to the following composition P₂O₅/Al₂O₃=0.8-2.0; TEAOH/Al₂O₃=1.0-2.0; H₂O/Al₂O₃=60-200. The film thickness is about 5 μm. The selectivity CH₄/CO₂ was calculated to be 53.

All the methods described in these patents are based on the two-step seeded hydrothermal gel method; AlPO/SAPO-18 crystallites (seeds) are deposited on a porous support, AlPO/SAPO-18 membrane gel is then put in contact with the porous support, the resulting system is heated to form an AlPO/SAPO-18 membrane layer and calcined.

Variations to this general procedure are described to improve the permeance and separation performance of membranes, e.g. the template/Al₂O₃ and H₂O/Al₂O₃ ratios [R. Zhou, J of Mater. Chem. A 2015] [R. Zhou et al., CN104150503, 2014], the number of layers [M. A. Carreon et al., Chem Comm. 2012] [Y. Sun et al., CN103449475, 2013], the porosity of the ceramic support [R. Zhou, J of Mater. Chem. A 2015], type of Al-source [M. A. Carreon et al., Chem Comm. 2012][Y. Sun et al., CN103449475. 2013] [R. Zhou et al., CN104150503, 2014], type of Si-source [R. Zhou et al., CN104150503, 2014], side of a ceramic support used for zeolite deposition [R. Zhou et al., J of Membr Sci. 2014] [R. Zhou et al., J of Mater. Chem. A 2015][M. A. Carreon et al., Chem Comm. 2012], temperature and time of zeolite layer crystallisation [Y. Sun et al., CN103449475, 2013] [R. Zhou et al., CN104150503, 2014], calcination temperature [Y. Sun et al., CN103449475, 2013] [R. Zhou et al., CN104150503, 2014], separation conditions variation [R. Zhou et al., CN104785125, 2015].

US 2003/129128 describes the formation of SAPO molecular sieves including the introduction of a source of metal including metal particles smaller or equal than 5 nm.

CN 103 964 457 describes SAPO like molecular sieves having a “sheet-like structure” for MTO applications.

US 2007/265484 discloses layer of SAPO-34 on a support to form membranes. The method of preparation includes contacting a porous membrane support with a synthesis gel. The Si/AI ratio of the synthesis gel can be from 0.3 to 0.15.

U.S. Pat. No. 6,903,240 discloses the production of small particle size SAPO-34 obtained using tetra alkyl orthosilicate as the silicon source.

However, there is still a need to improve the permeance and separation performance of membranes. There is also a need to provide a method to produce separation membranes with good permeance and separation performance that is cost effective.

### SUMMARY OF THE INVENTION

According to a first aspect, the invention provides a method for preparing a MeAPO-18 supported membrane comprising a MeAPO-18 crystal layer on a porous support, said method comprising the steps of:
a) providing a porous support;
b) providing MeAPO-18 crystal seeds with a lamellar crystal morphology;
c) seeding the porous support of step a) with the MeAPO-18 crystal seeds of step b), in order to obtain a seeded porous support;
d) providing a growing mixture containing a texture influencing agent (TIA), an organic templating agent (TEMP), at least a reactive inorganic source of MeO₂ insoluble in the TIA, reactive sources of Al₂O₃ and P₂O₅, said growing mixture having a composition expressed in terms of molar oxide ratios of:
   TEMP/Al₂O₃=0.3-5/1.0,
   P₂O₅/Al₂O₃=0.5-2/1.0,
   TIA/Al₂O₃=3-30/1.0,
   MeO₂/Al₂O₃=0.005-2.0/1.0,
   optionally H₂O/Al₂O₃=5 to 100/1.0
e) contacting the seeded porous support of step c) with the growing mixture of step d) at a synthesis temperature ranging from 373 K to 623 K for about 2 to 200 hours, in order to have a MeAPO-18 supported membrane growing;
f) removing the organic templating agent;
wherein Me is a metal selected from the group consisting of silicon, germanium, magnesium, zinc, iron, cobalt, nickel, manganese, chromium and mixtures thereof;
wherein TIA is selected from acetone, 1,2-propanediol, 1,3-propanediol, methanol, ethanol, propanol, isopropanol, butanol, and ethylene glycol or any mixture thereof.

A lamellar crystal morphology refers to crystals having the shape of a simple polygon comprised in a square.

MeAPO-18 crystal seeds with lamellar crystal morphology are known to the person skilled in the art. According to a definition, a lamellar crystal is a crystal of large extension in two dimensions and of relatively small and uniform thickness. For instance, a lamellar crystal may have a thickness between 5 and 50 nm, while the width is over 1 μm. According to the invention, MeAPO-18 crystal seeds with lamellar crystal morphology are crystal seeds for which the width (W) and the thickness (T) are such as W/T is ≥10, preferably ranging from 10 to 100.

It has been found that preparing MeAPO-18 membranes in the presence of one texture influencing agent instead of water and template allowed to improve the permeance and separation performance of the membrane produced. Moreover, the membrane produced shows also improvement of the thickness of the MeAPO-18 layer with a thickness of less than 5 μm obtained in a reproducible manner. The amount of template used to produce the membrane is reduced as it is partially substituted by the texture influenced agent rendering the method more cost effective. The presence of the texture influencing agent is also interesting because it at least partially or totally replaces water leading to less water consumption. Indeed water exiting the process needs to be treated in costly water treatment processes whereas the texture influencing agent is simply burnt during calcination.

It is noted that the use of a texture influenced agent to produce zeolite catalysts was described U.S. Pat. No. 8,518,370. However, this document is silent regarding the possibility to produce zeolite supported membranes. The texture influencing agent is selected from alcohols, ketones, aldehydes, diols and acids.

With preference, one or more of the following features can be used to further define the inventive method:
The MeAPO-18 supported membrane is selected from a crystalline silicoaluminophosphate-18 (SAPO-18) membrane.
The growing mixture has a composition expressed in terms of molar oxide ratios of:
   TEMP/Al₂O₃=0.5-2/1.0, preferably 0.7-2/1.0, more preferably 0.8-1.5/1.0, even more preferably 0.8-1.1/1.0 and most preferably 1.0/1.0,
   P₂O₂/Al₂O₃=0.8-1.2/1.0,
   TIA/Al₃O₃=6-20/1.0,
   MeO₂/Al₂O₃=0.022-0.8/1.0, preferably 0.05-0.6/1.0,
   optionally H₂O/Al₂O₃=5 to 100/1.0 preferably 12/1.0 to 60/1.0 more preferably 15/1.0 to 30/1.0 the most preferred is 17/1.0
Me is a metal selected from the group consisting of silicon, magnesium, cobalt, germanium and mixture thereof; more preferably, Me is silicon.
The texture influencing agent (TIA) could also be a C₁-C₅ oxygenated hydrocarbon, or the TIA could be selected from alcohols, ketones, aldehydes, diols and acids; the TIA is selected from Acetone, 1,2-propanediol, 1,3-propanediol, methanol, ethanol, propanol, isopropanol, butanol, and ethylene glycol; even more preferably the TIA is selected from alcohol or glycerol, and most preferably the TIA is ethanol and/or ethylene glycol.
Other texture influencing agent (TIA) can be selected from alcohols, ketones, aldehydes, diols and acids.
The organic templating agent (TEMP) is a tetraethylammonium compound selected from the group of tetraethylammonium hydroxide (TEAOH), tetraethylammonium phosphate, tetraethylammonium fluoride, tetraethylammonium bromide, tetraethylammonium chloride, tetraethylammonium acetate, preferably the organic templating agent is tetraethylammonium hydroxide (TEAOH).
The reactive source of Al₂O₃ is Al(OiPr)₃.
The reactive source of P₂O₅ is phosphoric acid.
Step e) of growing of the membrane is conducted at a synthesis temperature ranging from 393 K to 523 K, preferably ranging from 423 K to 473 K.
Step e) of growing of the membrane is conducted for about 16 to 96 hours, preferably for about 24 to 72 hours.
A step of washing of the MeAPO-18 supported membrane obtained in step e) with water is performed before the step f) of calcinating the MeAPO-18 supported membrane.
The step e) defines a synthesis cycle and is repeated at least one time in order to perform at least two synthesis cycles, preferably at least two times, more preferably at least three times and even more preferably at least four times.
The MeAPO-18 crystal seeds have an average size from 0.01 to 500 μm, preferably ranging from 0.1 to 200 μm, more preferably from 5 to 100 μm.
The molar oxide ratios of said growing mixture H₂O/Al₂O₃ ranges from 12/1.0 to 60/1.0 preferably 15/1.0 to 30/1.0 and most preferably is 17/1.0.

The step f) of removing the templating agent is preferably done:
by calcination in a thermostatic oven, or
by calcination in a microwave oven, or
by plasma treatment.

In an embodiment, the step f) of removing the templating agent is done by calcination in a thermostatic oven by heating up to a calcination temperature ranging from 633 K to 773 K for 8 to 20 hours in the presence of 1 to 100 vol % of oxygen.

In another embodiment, the step f) of removing the templating agent is done by calcination in a microwave oven by heating up to a calcination temperature ranging from 473 K to 673 K for 8 to 20 hours.

In another embodiment, the step f) of removing the templating agent is done by a plasma treatment by heating up to a temperature ranging from 293 K to 473 K.

With preference, the step b) comprises the preparation of said MeAPO-18 crystal seeds with a lamellar crystal morphology and comprises, therefore, the steps of:
i) forming a reaction mixture containing a texture influencing agent (TIA), an organic templating agent (TEMP), at least a reactive inorganic source of MeO₂ insoluble in the TIA, reactive sources of Al₂O₃ and P₂O₅, said reaction mixture having a composition expressed in terms of molar oxide ratios of:
   TEMP/Al₂O₃=0.3-5/1.0,
   P₂O₅/Al₂O₃=0.5-2/1.0,
   TIA/Al₂O₃=3-30/1.0,
   MeO₂/Al₂O₃=0.005-2.0/1.0,
   optionally H₂O/Al₂O₃=5 to 100/1.0 preferably 12/1.0 to 60/1.0 more preferably 15/1.0 to 30/1.0 the most preferred 17/1.0
ii) crystallizing the above reaction mixture thus formed until MeAPO-18 crystals seeds are formed;
iii) recovering a solid reaction product,
iv) optionally washing the solid reaction product recovered in step iii) with water;
v) optionally drying the solid reaction product of step iii), or of step iv) if a step iv) is performed; and
vi) recovering MeAPO-18 crystal seeds wherein the MeAPO-18 crystal seeds with lamellar crystal morphology and are preferably selected from SAPO-18 crystals or AlPO-18 crystals.

In a preferred embodiment, the growing mixture and the reaction mixture have the same composition.

In a preferred embodiment, step b) comprises providing MeAPO-18 crystal seeds with a lamellar crystal morphology (i.e. crystals having the shape of a simple polygon comprised in a square) having an empirical chemical composition on an anhydrous basis, after synthesis and calcination, expressed by the formula:

HₓMe_{y}Al_{z}PₖO₂
wherein, y+z+k=1 and x≤y
x has a value ranging from 0 to 0.4;
y has a value ranging from 0.0008 to 0.4;
z has a value ranging from 0.25 to 0.67;
k has a value ranging from 0.2 to 0.67;
wherein the x, y, z, and k are determined with ASTM UOP961 revised in 2012
   wherein more than 50 wt % of the crystals as based on the total weight of the MeAPO-18 crystal seeds have a lamellar crystal morphology in which the width (W) and the thickness (T) are such as W/T is ≥10.

With preference, one or more of the following features can be used to further define the MeAPO-18 crystal seeds used in step b) of the inventive method:
x has a value ranging from 0.0008 to 0.3 preferably from 0.005 to 0.18, more preferably from 0.011 to 0.16.
y has a value ranging from 0.005 to 0.18, more preferably from 0.011 to 0.16.
z has a value ranging from 0.38 to 0.55, preferably from 0.40 to 0.55.
k has a value ranging from 0.36 to 0.54, preferably from 0.38 to 0.54.
W/T is ranging from 10 to 100.
T is at most 0.10 μm, preferably at most 0.07 μm.
More than 80% by weight of the crystals as based on the total weight of the MeAPO-18 crystal seeds have the structure CHA or AEI or a mixture thereof.
The MeAPO-18 crystal seeds comprise more than 80 wt % as based on the total weight of MeAPO-18 crystal seeds being SAPO-18 crystals.

In a preferred embodiment, the porous support is selected from silica, alpha-alumina, gamma-alumina, mullite, zirconia, titania, yttria, silicon nitride, silicon carbide, iron, bronze and stainless steel, glass, and carbon.

Preferably the porous support is selected from disks, tubes and any shape incorporating multiples channels.

With preference, one or more of the following features can be used to further define the porous support used in the inventive method:
The porous support is alpha-alumina, preferably the porous support is tubular alpha-alumina.
The porosity of the porous support is ranging from 5 nm to 2000 nm, preferably from 5 nm to 1300 nm.

According to a second aspect, the invention provides a MeAPO-18 supported membrane made by the method described in the first aspect and in the detailed description of the invention.

The invention also provides a MeAPO-18 supported membrane comprising a MeAPO-18 crystal layer on a porous support characterised in that more than 50 wt % of the crystals as based on the total weight of the MeAPO-18 crystals have a lamellar crystal morphology in which the width (W) and the thickness (T) are such as W/T is ≥10, with preference made by the method according to the first aspect.

Preferably, the MeAPO-18 crystal layer is a crystalline silicoaluminophosphate-18 (SAPO-18) membrane.

The invention also provides a MeAPO-18 supported membrane comprising a MeAPO-18 crystal layer on a porous support wherein the MeAPO-18 crystal layer is a crystalline silicoaluminophosphate-18 (SAPO-18).

In a preferred embodiment, the MeAPO-18 supported membrane is comprising a MeAPO-18 crystal layer on a porous support, and is remarkable in that the MeAPO-18 crystals have a lamellar crystal morphology and an empirical chemical composition on an anhydrous basis, after synthesis and calcination, expressed by the formula:

HₓMe_{y}Al_{z}PₖO₂

wherein, y+z+k=1 and x≤y
x has a value ranging from 0 to 0.4;
y has a value ranging from 0.0008 to 0.4;
z has a value ranging from 0.25 to 0.67;
k has a value ranging from 0.2 to 0.67;
wherein the x, y, z, and k are determined with ASTM UOP961 revised in 2012.

Preferably, more than 50 wt % of the crystals as based on the total weight of the MeAPO-18 crystals have a lamellar crystal morphology in which the width (W) and the thickness (T) are such as W/T is ≥10.

In a preferred embodiment, the membrane according to the third aspect is made by the method described in the first aspect and in the detailed description of the invention.

With preference, one or more of the following features can be used to further define the MeAPO-18 supported membrane according to the invention:
Me is Si.
W/T is ranging from 10 to 100.
x has a value ranging from 0.0008 to 0.3 preferably from 0.005 to 0.18, more preferably from 0.011 to 0.16.
y has a value ranging from 0.0008 to 0.3 preferably from 0.005 to 0.18, more preferably from 0.011 to 0.16.
z has a value ranging from 0.38 to 0.55, preferably from 0.40 to 0.55.
k has a value ranging from 0.36 to 0.54, preferably from 0.38 to 0.54.
T is at most 0.10 μm, preferably at most 0.07 μm.
The porous support is selected from silica, alpha-alumina, gamma-alumina, mullite, zirconia, titania, yttria, silicon nitride, silicon carbide, iron, bronze and stainless steel, glass, and carbon.
The porous support is selected from disks, tubes and any shape incorporating multiples channels.
The porous support is alpha-alumina, preferably the porous support is tubular alpha-alumina.
The porosity of the porous support is ranging from 5 nm to 2000 nm, preferably from 5 nm to 1300 nm.
The MeAPO-18 crystal layer has a thickness of at most 5 μm or of at most 4 μm, preferably of at most 3 μm, even more preferably at most 2 μm, most preferably of at most 1.5 μm and even most preferably of at most 1.0 μm or of at most 0.9 μm.
The MeAPO-18 supported membrane is a crystalline silicoaluminophosphate-18 (SAPO-18) membrane.
The MeAPO-18 crystal seeds have an average size from 0.01 to 500 μm, preferably ranging from 0.1 to 200 μm, more preferably from 5 to 100 μm.

According to a third aspect, the invention provides the use of a membrane according to the second aspect or according to the detailed description of the invention in a method for separating gas mixtures or gas-liquid mixtures or liquid mixtures.

In a preferred embodiment, the invention provides the use of a membrane according to the second aspect or according to the detailed description of the invention in a method for separating a first gas component from a mixture comprising at least a first gas component and a second gas component, wherein the method comprises the steps of:
providing a MeAPO-18 supported membrane, the membrane having a feed and permeate side and being selectively permeable to the first gas component over the second gas component;
applying a feed stream including the first and the second gas component to the feed side of the membrane; and
providing a pressure drop sufficient for permeation of the first gas component through the membrane, thereby producing a permeate stream enriched from the first gas component from the permeate side of the membrane.

With preference, the first gas component is carbon dioxide and the second gas component is methane.

Indeed, the MeAPO-18 membranes of the invention are useful in a variety of purification processes for both gas-gas separation, for liquid-liquid separation and for gas-liquid separation.

According to a fourth aspect, the invention provides the use of a membrane according to the second aspect or according to the detailed description of the invention as membrane reactor membrane reactor in a process in order to extract a specific co-product from a reaction zone MeAPO-18 supported membranes of the invention can be used as well in membrane reactors in extraction mode to extract a specific co-product from the reaction zone, hence boosting conversion and enhancing selectivity towards the desired product by avoiding competitive reactions.

### DETAILED DESCRIPTION OF THE INVENTION

For the purpose of the invention the following definitions are given: The term MeAPO-18 refers aluminosilicate or zeotype with a chemical composition and crystallographic structure similar to a SAPO-18 but with silicon being replaced by Me which is a metal selected from the group consisting of silicon, germanium, magnesium, zinc, iron, cobalt, nickel, manganese, chromium.

The terms “templating agent” or “template” refer to species added to the synthesis media (herein in the growing mixture and in the reaction mixture) to aid in and/or guide the polymerization and the organization of the building blocks that form the crystal frameworks.

The terms “plate crystal morphology” or “lamellar crystal morphology” relate to crystals having the shape of a simple polygon comprised in a square wherein the square's width is named W.

The terms “comprising”, “comprises” and “comprised of” as used herein are synonymous with “including”, “includes” or “containing”, “contains”, and are inclusive or open-ended and do not exclude additional, non-recited members, elements or method steps. The terms “comprising”, “comprises” and “comprised of” also include the term “consisting of”.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of endpoints also includes the recited endpoint values themselves (e.g. from 1.0 to 5.0 includes both 1.0 and 5.0). Any numerical range recited herein is intended to include all sub-ranges subsumed therein.

The particular features, structures, characteristics or embodiments may be combined in any suitable manner, as would be apparent to a person skilled in the art from this disclosure, in one or more embodiments.

### Method to Produce the MeAPO-18 Supported Membrane

The invention provides a method for preparing a MeAPO-18 supported membrane comprising a MeAPO-18 crystal layer on a porous support, said method comprising the steps of:
a) providing a porous support;
b) providing MeAPO-18 crystal seeds with a lamellar crystal morphology;
c) seeding the porous support of step a) with the MeAPO-18 crystal seeds of step b), in order to obtain a seeded porous support:
d) providing a growing mixture containing a texture influencing agent (TIA), an organic templating agent (TEMP), at least a reactive inorganic source of MeO₂ insoluble in the TIA, reactive sources of Al₂O₃ and P₂O₅, said growing mixture having a composition expressed in terms of molar oxide ratios of:
   TEMP/Al₂O₃=0.3-5/1.0,
   P₂O₅/Al₂O₃=0.5-2/1.0,
   TIA/Al₂O₃=3-30/1.0,
   MeO₂/Al₂O₃=0.005-2.0/1.0,
   optionally H2O/Al₂O₃=5 to 100/1.0 preferably 12/1.0 to 60/1.0 more preferably 15/1.0 to 30/1.0 the most preferred 17/1.0
e) contacting the seeded porous support of step c) with the growing mixture of step d) at a synthesis temperature ranging from 373 K to 623 K for about 2 to 200 hours, in order to have a MeAPO-18 supported membrane growing;
f) removing the organic templating agent.

In a preferred embodiment, the MeAPO-18 supported membrane produced by the method of the invention is selected from a crystalline silicoaluminophosphate-18 (SAPO-18) membrane. In a preferred embodiment, the step e) defines a synthesis cycle and is repeated at least one time in order to perform at least two synthesis cycles, preferably at least two times, more preferably at least three times and even more preferably at least four times.

### Method to Produce the MeAPO-18 Crystal Seeds

In a preferred embodiment, the step b) comprises the preparation of said MeAPO-18 crystal seeds with a lamellar crystal morphology, comprising the step of:
i) forming a reaction mixture containing a texture influencing agent (TIA), an organic templating agent (TEMP), at least a reactive inorganic source of MeO₂ insoluble in the TIA, reactive sources of Al₂O₃ and P₂O₅, said reaction mixture having a composition expressed in terms of molar oxide ratios of:
   TEMP/Al₂O₃=0.3-5/1.0,
   P₂O₅/Al₂O₃=0.5-2/1.0,
   TIA/Al₂O₃=3-30/1.0,
   MeO₂/Al₂O₃=0.005-2.0/1.0,
   optionally H₂O/Al₂O₃=5 to 100/1.0 preferably 12/1.0 to 60/1.0 more preferably 15/1.0 to 30/1.0 the most preferred 17/1.0
ii) crystallising the above reaction mixture thus formed until MeAPO-18 crystals seeds are formed;
iii) recovering a solid reaction product,
iv) optionally washing solid reaction product recovered in step iii) with water;
v) optionally drying the solid reaction product of step iii), or of step iv) if a step iv) is performed; and
vi) recovering MeAPO-18 crystal seeds wherein the MeAPO-18 crystal seeds with lamellar crystal morphology and are preferably selected from SAPO-18 crystals or AlPO-18 crystals.

In an embodiment, the MeAPO-18 crystal seeds are not calcined before being deposited on the support.

In a preferred embodiment, the step b-ii) to crystallise the MeAPO-18 crystal seeds is conducted at a temperature ranging from 373 K to 623 K, preferably from 393 K to 523 K, more preferably from 423 K to 473 K.

Heating up to the crystallisation temperature is preferably carried out for a period of time ranging from about 0.5 to 16 hours, preferably from 1 to 12 hours, more preferably from 2 to 9 hours. The temperature may be increased stepwise or continuously. Continuous heating is preferred. The reaction mixture may be kept static or agitated by means of tumbling or stirring the reaction vessel during hydrothermal treatment. With preference, the reaction mixture is stirred. The temperature is then maintained at the crystallisation temperature for a period of time ranging from 2 to 200 hours. Heat and agitation are applied for a period of time effective to form a crystalline product. In a preferred embodiment, the reaction mixture is kept at the crystallisation temperature for a period of from 16 to 96 hours.

### The Porous Support

The porous support is a body capable of supporting the MeAPO-18 membrane. The porous support may be of any shape, including disks, tubes or a shape incorporating multiples channels. In an embodiment, the support is in the shape of a tube. In an embodiment, the support has two sides (e.g. the inside and the outside of a tube). Preferably, the support is seeded on only one side.

The support is made of a metal or an inorganic material. Preferably, the porous support of the invention is selected from silica, alpha-alumina, gamma-alumina, mullite, zirconia, titania, yttria, silicon nitride, silicon carbide, iron, bronze and stainless steel, glass, and carbon, preferably the porous support is alpha-alumina, more preferably the porous support is tubular alpha-alumina.

Advantageously, the porosity of the porous support is ranging from 5 nm to 2000, preferably from 5 nm to 1300 nm, more preferably from 5 nm to 400 nm, and most preferably from 5 nm to 100 nm.

Preferably the porous support is cleaned prior to being seeded. The support may be cleaned by being boiled in purified water. After being cleaning with water, the support may then be dried.

### The Gel Composition

The membranes of the invention are prepared by secondary seeded growth with a growing mixture preferably comprising an aluminophosphate gel or a silicoaluminophosphate gel. The growing mixture used in the invention to prepare the membrane from the MeAPO-18 crystal seeds may be the same that the reaction mixture used to prepare said MeAPO-18 crystal seeds or can be slightly different. The following considerations apply to both the growing mixture of step d) and the reaction mixture used in step b-i) to prepare the MeAPO-18 crystal seeds.

The preferred composition may vary depending on the crystallised temperature and time. The growing/reaction mixture is prepared by mixing sources of aluminium, phosphorus, oxygen and optionally metal (preferably being silicon) in the presence of a templating agent and a texture influencing agent.

The growing/reaction mixture contains an organic templating agent (TEMP). The organic templating agent can be any template used in the art in the synthesis of conventional zeolitic aluminosilicates and microporous aluminophosphates.

In general, these compounds contain elements of Group VA of the Periodic Table of Elements, particularly nitrogen, phosphorus, arsenic and antimony, preferably N or P and most preferably N, which compounds also contain at least one alkyl or aryl group having from 1 to 8 carbon atoms. Particularly preferred nitrogen-containing compounds for use as templating agents are the amines and quaternary ammonium compounds, the latter being represented generally by the formula R₄N⁺ wherein each R is an alkyl or aryl group containing from 1 to 8 carbon atoms. Polymeric quaternary ammonium salts such as [(C₁₄H₃₂N₂)(OH)₂]x wherein “x” has a value of at least 2 are also suitably employed. Both mono-, di and tri-amines are advantageously utilised, either alone or in combination with a quaternary ammonium compound or other templating compounds.

Representative templating agents include tetramethylammonium, tetraethylammonium, tetrapropylammonium or tetrabutylammonium cations; di-n-propylamine, tripropylamine, triethylamine; diethylamine, triethanolamine; piperidine; morpholine; cyclohexylamine; 2-methylpyridine; N,N-dimethylbenzylamine; N,N-diethylethanolamine; dicyclohexylamine; N,N-dimethylethanolamine; choline; N1N′-dimethylpiperazine; 1,4-diazabicyclo(2,2,2)octane; N-methyldiethanolamine, N-methylethanolamine; N-methylpiperidine; 3-methylpiperidine; N-methylcyclohexylamine; 3-methylpyridine; 4-methylpyridine; quinuclidine; N1N′-dimethyl-1,4-diazabicyclo(2,2,2)octane ion; di-n-butylamine, neopentylamine; di-n-pentylamine; isopropylamine; t-butylamine; ethylenediamine; pyrrolidine; and 2-imidazolidone.

Advantageously organic templating agent is selected among tetraethylammonium hydroxide (TEAOH), diisopropylethylamine (DPEA), tetraethylammonium salts, cyclopentylamine, aminomethyl cyclohexane, piperidine, triethylamine, diethylamine, cyclohexylamine, triethyl hydroxyethylamine, morpholine, dipropylamine, pyridine, isopropylamine di-n-propylamine, tetra-n-butylammonium hydroxide, diisopropylamine, di-n-propylamine, n-butylethylamine, di-n-butylamine, and di-n-pentylamine and combinations thereof.

In an embodiment, the organic templating agent (TEMP) is a tetraethylammonium compound selected from the group of tetraethylammonium hydroxide (TEAOH), tetraethylammonium phosphate, tetraethylammonium fluoride, tetraethylammonium bromide, tetraethylammonium chloride, tetraethylammonium acetate, preferably the organic templating agent is tetraethylammonium hydroxide (TEAOH).

In an embodiment, the texture influencing agent (TIA) is selected from alcohols, ketones, aldehydes, diols and acids

The texture influencing agent (TIA) is a C₁-C₅ oxygenated hydrocarbon, preferably the TIA is selected from alcohols, ketones, aldehydes, diols and acids.

In an embodiment, the texture influencing agent is selected from Acetone, 1,2-propanediol, 1,3-propanediol, methanol, ethanol, propanol, isopropanol, butanol, and ethylene glycol; preferably the texture influencing agent is selected from alcohol or glycerol, and more preferably the texture influencing agent is ethanol and/or ethylene glycol.

The reactive source of Al₂O₃ can be any aluminium species capable of being dispersed or dissolved in an alcohol synthesis solution. In an embodiment, the source of alumina is an aluminium alkoxide such as aluminium isopropoxide or an aluminium hydroxide. Useful sources of alumina can also be one or more sources selected from hydrated alumina, organo-alumina, pseudo-boehmite, colloidal alumina, aluminium halides, aluminium carboxylates, aluminium sulphates and mixtures thereof.

In an embodiment, the reactive source of Al₂O₃ is organo-alumina, preferably the reactive source of Al₂O₃ is Al(OiPr)₃.

The reactive sources of P₂O₅ can be any phosphorous species capable of being dispersed or dissolved in an alcohol synthesis solution. Useful sources are one or more sources selected from: phosphoric acid, organic phosphates, crystalline and amorphous aluminophosphates and mixtures thereof. Useful organic phosphates are for example triethyl phosphate, tetraethylammonium phosphate.

In an embodiment, the reactive source of P₂O₅ is phosphoric acid.

The growing mixture and the reaction mixture are in the form of gels. The growing mixture and the reaction mixture have preferably the same composition but may have a different composition. The growing mixture and the reaction mixture can be prepared in accordance with the following compositions.

In the growing/reaction, the reactive inorganic source of MeO₂, wherein Me is a metal selected from the group consisting of silicon, germanium, magnesium, zinc, iron, cobalt, nickel, manganese, chromium and mixtures thereof, preferably selected from silicon, magnesium, cobalt, germanium and mixture thereof; more preferably, Me is silicon. The MeO₂ is to be selected to be insoluble in the texture influencing agent (TIA).

When MeO₂ is SiO₂, non-limiting examples of useful inorganic silicon source material non-soluble in alcohols include fumed silica, pyrogenic silica, precipitated silica and silica gel. These source materials are insoluble in the texture influencing agent (TIA) being an alcohol or a glycol.

In an embodiment of the invention, the growing/reaction mixture comprises MeO₂ and the growing mixture has a composition expressed in terms of molar oxide ratios of TEMP/Al₂O₃=0.3-5/1.0; MeO₂/Al₂O₃=0.005-2.0/1.0; P₂O₅/Al₂O₃=0.5-2/1.0; TIA/Al₂O₃=3-30/1.0; and optionally H₂O/Al₂O₃=5-17/1.0.

In an embodiment, the growing/reaction mixture has a composition expressed in terms of molar oxide ratios of TEMP/Al₂O₃=0.5-2/1.0; MeO₂/Al₂O₃=0.022-0.8/1.0; P₂O₅/Al₂O₃=0.8-1.2/1.0; TIA/Al₂O₃=6-20/1.0; and optionally H₂O/Al₂O₃=5-17/1.0.

In another embodiment, the growing/reaction mixture has a composition expressed in terms of molar oxide ratios of TEMP/Al₂O₃=0.5-2/1.0; MeO₂/Al₂O₃=0.022-0.7/1.0; P₂O₅/Al₂O₃=0.8-1.2/11.0; TIA/Al₂O₃=6-20/1.0; and optionally H₂O/Al₂O₃=5-17/1.0.

In an advantageous embodiment, the growing/reaction mixture has a composition expressed in terms of molar oxide ratios of TEMP/Al₂O₃=0.7-2/1.0; MeO₂/Al₂O₃=0.022-0.7/1.0; P₂O₅/Al₂O₃=0.8-1.2/1.0; TIA/Al₂O₃=6-20/1.0; and optionally H₂O/Al₂O₃=5-17/1.0.

In a more advantageous embodiment, the growing/reaction mixture has a composition expressed in terms of molar oxide ratios of TEMP/Al₂O₃=0.7-2/1.0; MeO₂/Al₂O₃=0.05-0.7/1.0; P₂O₅/Al₂O₃=0.8-1.2/1.0; TIA/Al₂O₃=6-20/1.0; and optionally H₂O/Al₂O₃=5-17/1.0.

In a preferred embodiment, the growing/reaction mixture has a composition expressed in terms of molar oxide ratios of TEMP/Al₂O₃=0.7-1.1/1.0; MeO₂/Al₂O₃=0.05-0.6/1.0; P₂O₅/Al₂O₃=0.8-1.2/1.0; TIA/Al₂O₃=6-20/1.0; and optionally H₂O/Al₂O₃=5-17/11.0.

The low content of MeO₂ (e.g. silicon) favours the formation of lamellar crystal morphology,

The person skilled in the art may adapt the ratio of Me to Al in order to favour the formation of MeAPO crystals over AlPO crystals or vice-versa. When the ratio of Me to Al is high enough the AlPO crystals are not formed. Preferably, Me is Si.

Optionally, the growing/reaction mixture is aged for 4 to 24 hours. Preferably the growing/reaction mixture is not aged.

### The MeAPO-18 Crystal Seeds

In a preferred embodiment, step b) comprises providing MeAPO-18 crystal seeds with a lamellar crystal morphology having an empirical chemical composition on an anhydrous basis, after synthesis and calcination, expressed by the formula:

HₓMe_{y}Al_{z}PₖO₂

wherein, y+z+k=1 and x≤y
x has a value ranging from 0 to 0.4;
y has a value ranging from 0.0008 to 0.4;
z has a value ranging from 0.25 to 0.67;
k has a value ranging from 0.2 to 0.67;
   wherein more than 50 wt % of the crystals as based on the total weight of the MeAPO-18 crystal seeds have a lamellar crystal morphology in which the width (W) and the thickness (T) are such as W/T is ≥10, and preferably W/T is ranging from 10 to 100.

In a preferred embodiment, T is at most 0.15 μm, preferably at most 0.10 μm. With preference, T is ranging from 0.01 to 0.07 μm, and preferably from 0.04 to 0.07.

In an embodiment, y has a value ranging from 0.005 to 0.18, z has a value ranging from 0.38 to 0.55 and k has a value ranging from 0.36 to 0.54.

In another embodiment, y has a value ranging from 0.005 to 0.16. z has a value ranging from 0.39 to 0.55 and k has a value ranging from 0.37 to 0.54.

In a further embodiment, y has a value ranging from 0.011 to 0.16, z has a value ranging from 0.39 to 0.55 and k has a value ranging from 0.37 to 0.54.

In a further embodiment, y has a value ranging from 0.011 to 0.14, z has a value ranging from 0.40 to 0.55 and k has a value ranging from 0.38 to 0.54.

In a preferred embodiment, more than 80% by weight of the MeAPO-18 crystals seeds as based on the total weight of the MeAPO-18 crystal seeds have the structure CHA or AEI or a mixture thereof, preferably more than 90 wt %.

With preference, the MeAPO-18 crystal seeds comprise more than 80 wt % as based on the total weight of MeAPO-18 crystal seeds, of crystals being selected from SAPO-18 crystals or AlPO-18 crystals; preferably more than 90 wt %.

In a preferred embodiment, the MeAPO-18 crystal seeds have an average size ranging from 5 nm to 5 μm.

In an embodiment, the MeAPO-18 crystal seeds have an average size that is larger than the average pore size of the support.

In another embodiment, the MeAPO-18 crystal seeds have an average size that is equal to or smaller than the average pore size of the support.

### The Step c) of Seeding the Porous Support

In a preferred embodiment, the seeding is performed by rubbing one side of the porous support with dry, un-calcined MeAPO-18 crystal seed. When the porous support is a tube, the seeded side is the inside surface of the tube, for example by the means of a cotton-tipped swab.

In another embodiment, the seeding is performed by dip-coating. This method includes immersing dry support in a suspension of MeAPO-18 crystal seeds in hydroxypropyl cellulose. After a period of time of about 25 seconds, the soaked support is lifted up, dried at 373 K for 2 hours and calcined in air at 673 K for 4 hours.

In a further embodiment, the seeding is performed by the use of a seeded growing mixture wherein the seeds are added to the growing mixture; preferably the seeds are added to the growing mixture in a TIA suspension preferably prepared by sonication.

### The Step e) of Growing the MeAPO-18 Layer on a Support

The synthesis temperature of step e) of growing the membrane and the crystallisation temperature of step b-ii) to crystallise the MeAPO-18 crystal seeds can be the same or different, preferably they are the same.

In a preferred embodiment, the step e) of growing of the membrane is conducted at a synthesis/crystallisation temperature ranging from 373 K to 623 K, preferably from 393 K to 523 K, more preferably ranging from 413 K to 463 K, even more preferably ranging from 423 K to 473 K and most preferably ranging from 433 K to 453 K.

Heating up to the synthesis temperature is preferably carried out for a period of time ranging from about 0.5 to 16 hours, preferably from 1 to 12 hours, more preferably from 2 to 9 hours. The temperature may be increased stepwise or continuously. Continuous heating is preferred.

In a preferred embodiment, the step e) of growing of the membrane is conducted for about 2 to 200 hours, preferably from 16 to 96 hours, more preferably for about 24 to 72 hours.

In a preferred embodiment, the steps c) of seeding and the step e) of growing the membrane are only performed once in order to obtain a MeAPO-18 crystal layer. The steps c) of seeding is not repeated, but the step e) of growing the membrane is repeated if multiple synthesis cycles are required.

### The Step f) of Removing the Templating Agent

After the synthesis of the membrane is complete, the membrane is heated to remove the organic template material. After template removal, the membrane becomes a semi-permeable barrier that is capable of restricting the movement of molecules.

The step f) of removing the templating agent is preferably done:
by calcination in a thermostatic oven, or
by calcination in a microwave oven, or
by plasma treatment.

In an embodiment, the step f) of removing the templating agent is done by calcination in a thermostatic oven by heating up to a calcination temperature ranging from 633 K to 773 K for 8 to 20 hours in the presence of 1 to 100 vol % of oxygen.

In another embodiment, the step f) of removing the templating agent is done by calcination in a microwave oven by heating up to a calcination temperature ranging from 473 K to 673 K for 8 to 20 hours.

In another embodiment, the step f) of removing the templating agent is done by a plasma treatment by heating up to a temperature ranging from 293 K to 473 K.

Advantageously, the step f) of calcination of the MeAPO-18 crystals supported membrane is performed at a calcination temperature ranging from 663 K to 683 K for 8 to 20 hours. The membrane is preferably heated in an O₂ reduced atmosphere if calcining in thermostatic or microwave oven. An O₂ reduced atmosphere is a gas atmosphere containing less than 50 vol % of O₂ as beads on the total volume of the gas atmosphere.

With preference, a step of washing of the MeAPO-18 supported membrane obtained in step e) with water is performed before the step f) of calcinating the MeAPO-18 supported membrane.

In a preferred embodiment, an optional treatment step g) is performed after step f) in which the calcinated MeAPO-18 supported membrane is soaked in a saturated solution of beta-cyclodextrin in isopropanol at room temperature during at least 2 h or the calcinated MeAPO-18 supported membrane is soaked in an aqueous solution containing at least 2.5 wt % of beta-cyclodextrin at room temperature during at least 2 h; followed by a drying under air at room temperature for 4 h, followed by a drying under air for at least 12 h at a temperature ranging from 150 to 250° C. preferably at 200° C.

### The MeAPO-18 Supported Membrane

The invention provides a MeAPO-18 supported membrane made by the method described above.

According to the invention, the MeAPO-18 supported membrane comprises a MeAPO-18 crystal layer on a porous support. The MeAPO-18 supported membrane of the invention is remarkable in that the MeAPO-18 crystals have a lamellar crystal morphology and an empirical chemical composition on an anhydrous basis, after synthesis and calcination, expressed by the formula:

HₓMe_{y}Al_{z}PₖO₂

wherein, y+z+k=1 and x≤y
x has a value ranging from 0 to 0.4;
y has a value ranging from 0.0008 to 0.4;
z has a value ranging from 0.25 to 0.67;
k has a value ranging from 0.2 to 0.67;
   wherein more than 50 wt % of the crystals as based on the total weight of the MeAPO-18 crystal seeds have a lamellar crystal morphology in which the width (W) and the thickness (T) are such as W/T is ≥10, preferably ranging from 10 to 100.

In a preferred embodiment, Me is selected from Si, Mg, Co, Ge, Zn, Fe, Ni and any mixture of thereof, preferably from Si, Mg, Co, Ge and any mixture thereof, more preferably Me is Si.

Preferably, the MeAPO-18 supported membrane is selected from a crystalline silicoaluminophosphate-18 (SAPO-18) membrane or a crystalline aluminophosphate-18 (AlPO-18) membrane.

In a preferred embodiment, T is at most 0.15 μm, preferably at most 0.10 μm. With preference, T is ranging from 0.01 to 0.07 μm, and preferably from 0.04 to 0.07.

In an embodiment, y has a value ranging from 0.005 to 0.18, z has a value ranging from 0.38 to 0.55 and k has a value ranging from 0.36 to 0.54.

In another embodiment, y has a value ranging from 0.005 to 0.16, z has a value ranging from 0.39 to 0.55 and k has a value ranging from 0.37 to 0.54.

In a further embodiment, y has a value ranging from 0.011 to 0.16, z has a value ranging from 0.39 to 0.55 and k has a value ranging from 0.37 to 0.54.

In a further embodiment, y has a value ranging from 0.011 to 0.14, z has a value ranging from 0.40 to 0.55 and k has a value ranging from 0.38 to 0.54.

In a further embodiment, y has a value of 0, z has a value ranging from 0.40 to 0.55 and k has a value ranging from 0.38 to 0.54.

Preferably, the porous support is selected from silica, alpha-alumina, gamma-alumina, mullite, zirconia, titania, yttria, silicon nitride, silicon carbide, iron, bronze and stainless steel, glass, and carbon, preferably the porous support is alpha-alumina, more preferably the porous support is tubular alpha-alumina.

In a preferred embodiment, the MeAPO-18 crystal layer has a thickness of at most 5 μm or of at most 4 μm, preferably of at most 3 μm, even more preferably at most 2 μm, most preferably of at most 1.5 μm and even most preferably of at most 1.0 μm or of at most 0.9 μm.

In a preferred embodiment, the average pore size of the membrane is 0.38 nm.

### Inventive Uses of the MeAPO-18 Supported Membrane

MeAPO-18 membranes of the invention are useful in a variety of purification processes for both gas-gas and liquid-liquid separations and the mixture of thereof.

For example, the MeAPO-18 supported membrane can be used in a method for separating a first gas component from a mixture comprising at least a first gas component and a second gas component, wherein the method comprises the steps of:
providing a MeAPO-18 supported membrane, the membrane having a feed and permeate side and being selectively permeable to the first gas component over the second gas component;
applying a feed stream including the first and the second gas component to the feed side of the membrane; and
providing a pressure drop sufficient for permeation of the first gas component through the membrane, thereby producing a permeate stream enriched from the first gas component from the permeate side of the membrane.

Preferably, the first gas component is carbon dioxide and the second gas component is methane.

MeAPO-18 supported membranes of the invention can be used as well in membrane reactors in extraction mode to extract a specific co-product from the reaction zone, hence boosting conversion and enhancing selectivity towards the desired product by avoiding competitive reactions.

### Test Methods

The average pore size of the support and the pore size of the membrane are determined by permporometry as described in C. Z. Cao, J. Meijerink, H. W. Brinkman, A. J. Burggraff Journal of Membrane Science 83 (1993), 221 especially in the paragraph relating to permporometry.

The thickness of the MeAPO-18 crystal layer was determined by Scanning Electron Microscopy (SEM) and measuring the thickness of the MeAPO-18 crystal layer.

X-ray diffraction is used to determine the crystallographic structure of MeAPO-18 crystals. When only one phase was identified, it was assumed that a pure sample was obtained.

### EXAMPLES

The following examples illustrate the invention.

### Synthesis of MeAPOs Supported Membranes

A reaction mixture of TEAOH, aluminium iso-peroxide, ethanol, texture influencing agent (TIA), Aerosil (in the case of SAPOs) and phosphoric acid was prepared in Teflon vessels. This slurry was homogenised for 30 minutes each time after adding a further component. Then the Teflon vessel was inserted into a stainless autoclave. The autoclave was closed and kept at elevated temperatures. After cooling down to room temperature, a sample was taken, washed and dried. Separation of the solid and liquid phases after synthesis was performed by centrifugation. Separated solid was dried at 100° C. overnight. Proportions of the gel components and operating conditions are presented in Table 1. For all the preparations, the ratio of H₂O/Al (iC₃H₇O)₃ was equal to 17.

The example E4 was analysed via scanning electronic microscopy (SEM) with a 15 000 magnification a power of the electronic beam of 2 kV under secondary electron imaging and with a working distance of 3 mm and under acquisition mode GB_HIGH. The average crystal size of the SAPO-18 was measured at 20 μm. The other preparation methods (E1, E2, E3 and E5) showed a similar crystal size.

The resulted SAPOs powder has been used to seed the support of a ceramic membrane.

Porous ceramic tube with 5 nm mean surface pore size was used as support. The two ends were sealed with glaze. The external surface of the support was covered by Teflon tape upon cleaning and drying. The supports were seeded by rubbing the inside surface of the support using a pipe cleaner. In a typical synthesis, the composition of the membrane gel corresponds to the composition of the gel used in the preparation of the seeds (Table 1). After dry gel synthesis, the membranes were washed with deionised water thoroughly and dried. Template removal was carried out in a tubular furnace at 673 K for 10 h. The calcination heating and cooling rates were 1 K/min, respectively.

Each step of preparation of the crystal seeds and of preparation of the membrane lasted 72 hours in total.

In the below table:
Eth means ethanol
EG means ethylene glycol
XRD means X-ray diffraction
Aerosil 200 is a fumed silica supplied by Degussa

### Membrane Synthesis.

SAPO-18 membranes were prepared according to the method of preparation E4 and deposited on the inner surface of the macroporous support of α-Al2O3 obtained from the Fraunhofer Institut IKTS. The α-Al2O3 tubes have a length of 62.5 mm, 10 mm of outer diameter, 7 mm of internal diameter and 5 nm average pore size. The support was washed with boiling de ionized water for 30 min and dried at 373 K for 18 h. After that, the inner surface of α-alumina tubes was seeded by rubbing it with uncalcined SAPO-18 crystals. The synthesis gel was prepared using AI-isopropoxide as an Al-source, fumed SiO2 as a silica precursor, H₃PO₄ as a phosphorous source and TEAOH as a template. The final molar ratio was 1.0 Al₂O₃: 0.3 SiO₂: 1.0 P₂O₅: 1.0 TEAOH: 17 H₂O. The seeded supports were placed vertically in the autoclave filled with a synthesis gel. Hydrothermal treatment (heating in an autoclave under autogenous pressure) was carried out in the conventional oven at 433 K for 72 hours. The synthesised membranes were washed by DI water, soaked for 15 minutes and dried at 453 K under air for 18 h. The membranes were calcined in a temperature programmed furnace at 773 K under air for 8 hours with a heating ramp of 0.4 K/min and cooling ramp of 0.2 K/min. The calcined membranes were treated at 423 K under the vacuum for 18 h before the gas separations tests.

### Membrane Testing.

Mixed gas separations were measured without a sweep gas at the pressure drop maintained at 1.5 barg. The module temperature is kept at 22° C. and the feed pressure was 2.5 bars. The feed had a composition of CO₂/CH₄ (vol %/vol %, 50/50). Retentate and permeate composition were measured by a gas chromatograph having a thermal conductivity detector. The flow rate of a CO₂/CH₄ mixture was 0.024 Nm³/h. The selectivity is the ratio of permeance CO₂ to CH₄. CO₂ permeance is equal to 2.34*10−7 mol/m²*s*Pa, the selectivity CO₂/CH₄ is 29.3.

### Post-Treatment of the Membrane

The as synthesised membrane of SAPO-18 was calcined in a temperature programmed furnace at 773 K for 8 hours with a heating ramp of 0.4 K/min and cooling ramp of 0.2 K/min. The calcined membrane was treated at 423 K under the vacuum for 18 h before the single gas separation test. Permeate composition was measured by a gas chromatograph having a thermal conductivity detector. The selectivity is the ratio of a single permeance of CO2 to CH4. Before the post-treatment CO₂ single gas permeance is equal to 0.86*10−7 mol/m2*s*Pa, CH4 single gas permence is 0.16*10−7 mol/m2*s*Pa, the CO2/CH4 selectivity is 5.4.

After that, the membrane was treated by beta-cyclodextrin. To deposit beta-cyclodextrin in the membrane defects, this membrane was soaked in 0.5-5 wt % aqueous solutions of beta-cyclodextrin at room temperature for 5 min to 4 h. It was dried at room temperature for 4 h and stored at 473K for at least 12 h before the measurements. CO2 single gas permeance is equal to 0.43*10−7 mol/m2*s*Pa, CH4 single gas permence is 0.04*10−7 mol/m2*s*Pa, the CO2/CH4 selectivity is 9.8.

The post-treatment with beta-cyclodextrin allows improving the CO2/CH4 selectivity.

TABLE 1
Proportions of gel components and operating conditions for MeAPOs membranes

| | Molar composition of the reaction | | Aerosil | | | | time, | T, | |
|---|---|---|---|---|---|---|---|---|---|
| # | mixture and of the growing mixture | Al(iC₃H₇O)₃ | 200 | H₃PO₄ | TEAOH | TIA | h | ° C. | XRD |
| E1 | 1TEAOH/0.3SiO₂/1Al₂O₃/1P2O5/12Eth | 23.14 | 1.25 | 13.14 | 23.31 | 33.25 | 72 | 160 | SAPO-18 |
| E2 | 1TEAOH/0.3SiO₂/1Al₂O₃/1P2O5/12EG | 31.86 | 1.41 | 17.54 | 32.10 | 57.49 | 72 | 180 | SAPO-18 |
| E3 | 1TEAOH/1Al₂O₃/1P2O5/12Eth | 67.31 | 0.00 | 38.23 | 67.82 | 96.73 | 72 | 160 | AlPO-18 |
| E4 | 1TEAOH/0.1SiO₂/1Al₂O₃/1P2O5/12Eth | 32.80 | 0.47 | 18.69 | 33.04 | 47.13 | 72 | 160 | SAPO-18 |
| E5 | 1TEAOH/0.1SiO₂/1Al₂O₃/1P2O5/12Eth | 32.80 | 0.47 | 18.69 | 33.04 | 47.13 | 72 | 180 | SAPO-18 |

1.-18. (canceled)

19. A method for preparing a MeAPO-18 supported membrane comprising a MeAPO-18 crystal layer on a porous support, said method comprising:
a) providing a porous support;
b) providing MeAPO-18 crystal seeds with a lamellar crystal morphology;
c) seeding the porous support of step a) with the MeAPO-18 crystal seeds of step b), in order to obtain a seeded porous support;
d) providing a growing mixture containing a texture influencing agent (TIA), an organic templating agent (TEMP), at least a reactive inorganic source of MeO₂ insoluble in the TIA, reactive sources of Al₂O₃ and P₂O₅, said growing mixture having a composition expressed in terms of molar oxide ratios of:
TEMP/Al₂O₃=0.3-5/1.0,
P₂O₅/AI₂O₃=0.5-2/1.0,
TIA/AI₂O₃=3-30/1.0,
MeO₂/AI₂O₃=0.005-2.0/1.0,
optionally H2O/Al₂O₃=5 to 100/1.0
e) contacting the seeded porous support of step c) with the growing mixture of step d) at a synthesis temperature ranging from 373 K to 623 K for about 2 to 200 hours, in order to have a MeAPO-18 supported membrane growing;
f) removing the organic templating agent;
wherein Me is a metal selected from the group consisting of silicon, germanium, magnesium, zinc, iron, cobalt, nickel, manganese, chromium and mixtures thereof;
wherein TIA is selected from acetone, 1,2-propanediol, 1,3-propanediol, methanol, ethanol, propanol, isopropanol, butanol, and ethylene glycol or any mixture thereof.

20. The method according to claim 19 wherein the MeAPO-18 crystal seeds have an average size from 0.01 to 500 μm.

21. The method according to claim 19 wherein the molar oxide ratios of the growing mixture H₂O/Al₂O₃ ranges from 12/1.0 to 60/1.0.

22. The method according to claim 19, characterised in that the texture influencing agent (TIA) is selected from ethanol and/or ethylene glycol.

23. The method according to claim 19 wherein the organic templating agent (TEMP) is a tetraethylammonium compound selected from the group of tetraethylammonium hydroxide (TEAOH), tetraethylammonium phosphate, tetraethylammonium fluoride, tetraethylammonium bromide, tetraethylammonium chloride, tetraethylammonium acetate.

24. The method according to claim 19 wherein (b) comprises the preparation of the MeAPO-18 crystal seeds with a lamellar crystal morphology, and comprises:
i) forming a reaction mixture containing a texture influencing agent (TIA), an organic templating agent (TEMP), at least a reactive inorganic source of MeO₂ insoluble in the TIA, reactive sources of AI₂O₃ and P₂O₅, said reaction mixture having a composition expressed in terms of molar oxide ratios of:
TEMP/AI₂O₃=0.3-5/1.0,
P₂O₅/AI₂O₃=0.5-2/1.0,
TIA/AI₂O₃=3-30/1.0,
MeO₂/AI₂O₃=0.005-2.0/1.0,
optionally H₂O/Al₂O₃=5 to 100/1.0
ii) crystallising the above reaction mixture thus formed until MeAPO-18 crystals seeds are formed;
iii) recovering a solid reaction product,
iv) optionally washing the solid reaction product recovered in step iii) with water;
v) optionally drying the solid reaction product of step iii), or of step iv) if a step iv) is performed; and
vi) recovering MeAPO-18 crystal seeds wherein the MeAPO-18 crystal seeds with lamellar crystal morphology are SAPO-18 crystals.

25. The method according to claim 19 wherein Me is a metal selected from silicon, magnesium, cobalt, germanium and mixture thereof.

26. The method according to claim 19 wherein the growing mixture and the reaction mixture have the same composition.

27. The method according to claim 19 wherein (b) comprises providing MeAPO-18 crystal seeds with a lamellar crystal morphology having an empirical chemical composition on an anhydrous basis, after synthesis and calcination, expressed by the formula:
HₓMe_{y}Al_{z}PₖO₂
wherein, y+z+k=1 and x≤y
x has a value ranging from 0 to 0.4;
y has a value ranging from 0.0008 to 0.4;
z has a value ranging from 0.25 to 0.67;
k has a value ranging from 0.2 to 0.67;
wherein the x, y, z, and k are determined with ASTM UOP961 revised in 2012
wherein more than 50 wt % of the crystals as based on the total weight of the MeAPO-18 crystal seeds have a lamellar crystal morphology in which the width (W) and the thickness (T) are such as W/T is ≥10.

28. The method according to claim 19 wherein the MeAPO-18 crystal seeds comprise more than 80 wt % as based on the total weight of MeAPO-18 crystal seeds, of crystals being SAPO-18.

29. The method according to claim 19 wherein the porous support:
a. is selected from silica, alpha-alumina, gamma-alumina, mullite, zirconia, titania, yttria, silicon nitride, silicon carbide, iron, bronze and stainless steel, glass, and carbon; and/or
b. is selected from disks, tubes and any shape incorporating multiples channels.

30. The method according to claim 19 wherein:
(e) is repeated at least one time, and/or
the MeAPO-18 supported membrane is selected from a crystalline silicoaluminophosphate-18 (SAPO-18) membrane.

31. The method according to claim 19 wherein the removing of the organic template agent in (f) comprises:
calcination in a thermostatic oven, or
calcination in a microwave oven, or
plasma treatment.

32. A MeAPO-18 supported membrane comprising a MeAPO-18 crystal layer on a porous support characterised in that more than 50 wt % of the crystals as based on the total weight of the MeAPO-18 crystals have a lamellar crystal morphology in which the width (W) and the thickness (T) are such as W/T is ≥10.

33. A MeAPO-18 supported membrane according to claim 32 characterized in that the MeAPO-18 crystal layer is a crystalline silicoaluminophosphate-18 (SAPO-18) membrane.

34. A MeAPO-18 supported membrane according to claim 32, comprising a MeAPO-18 crystal layer on a porous support, characterised in that the MeAPO-18 crystals have a lamellar crystal morphology and an empirical chemical composition on an anhydrous basis, after synthesis and calcination, expressed by the formula:
HₓMe_{y}Al_{z}PₖO₂
wherein, y+z+k=1 and x≤y
x has a value ranging from 0 to 0.4;
y has a value ranging from 0.0008 to 0.4;
z has a value ranging from 0.25 to 0.67;
k has a value ranging from 0.2 to 0.67;
wherein the x, y, z, and k are determined with ASTM UOP961 revised in 2012.

35. The MeAPO-18 supported membrane according to claim 32 wherein the MeAPO-18 crystal layer has a thickness of at most 5 μm.

36. The use of a MeAPO-18 supported membrane according to claim 32:
a—in a method for separating gas mixtures or gas-liquid mixtures or liquid mixtures and/or
b—as membrane reactor in a process in order to extract a specific co-product from a reaction zone.
